(19) United States
(12) Patent Application Publication
(10) Pub. No.: US 2003/0093893 A1
(43) Pub. Date: May 22, 2003

(54) Method for manufacturing DC motor

(75) Inventor: Sung Tai Jung, Seoul (KR)

Correspondence Address: DARBY & DARBY P.C., 805 Third Avenue, New York, NY, 10022, US

(73) Assignee: SAMSUNG ELECTRO-MECHANICS CO., LTD., Suwon-Shi (KR)

(21) Appl. No.: 10/289,920

(22) Filed: Nov. 6, 2002

(30) Foreign Application Priority Data
Nov. 16, 2001 (KR) 2001-71333
Oct. 24, 2002 (KR) 2002-65352

(51) Int. Cl. H02K 15/00; H02K 21/12; H02K 1/22

(52) U.S. Cl. 29/596; 29/598; 310/261; 310/156.01

(57) ABSTRACT

Disclosed is a method for manufacturing a DC motor. The method comprises the steps of attaching a magnet to a circumferential inner surface of a case; rotatably assembling a rotator including a shaft, a coil and a core in a manner such that a predetermined air gap is defined between the magnet and the rotator; positioning the case having the magnet attached thereto, in a magnetizing yoke; and magnetizing the magnet.

### BACKGROUND OF THE INVENTION

1. Field of the Invention

The present invention relates to a method for manufacturing a small-sized DC motor, and more particularly, to a method for manufacturing a DC motor in which a magnet is magnetized after assembly of the motor is completed, to simplify a manufacturing procedure and improve driving characteristics.

2. Description of the Related Art

Generally, small-sized DC motors are used as driving means in various kinds of small-sized electric appliances and small-sized electronic appliances which require precise drivability. The small-sized DC motors are usually divided into a cored type and a coreless type.

FIG. 1 is a cross-sectional view illustrating the conventional cored type DC motor. As shown in FIG. 1, the DC motor (1) largely comprises a case (10) defining an outer body of the DC motor (1), a magnet (m), a rotator (20) and a power supply section (30).

The case (10) has a substantially tubular contour. When viewed on a plane of the drawing, an upper bearing (b1) for rotatably supporting an upper end of a shaft (s) is press-fitted into a cover member provided to an upper end of the case (10). An opened lower end of the case (10) is closed by a base (11). A hole through which a lower end of the shaft (s) is inserted is defined through a center portion of the base (11), and a lower bearing (b2) for rotatably supporting a lower end of the shaft (s) is press-fitted into the hole.

The magnet (m) is brought into close contact with a circumferential inner surface of the case (10), and interacts with a coil (22) of the rotator (20), as will be described below, to generate electromagnetic force.

The rotator (20) includes the shaft (s) centrally disposed in the case (10) and rotatably supported by the upper and lower bearings (b1 and b2), a core (21) fitted around the shaft (s), and the coil (22) wound on the core (21) with a predetermined air gap defined between the coil (22) and the magnet (m).

The power supply section (30) serves as a component element for externally receiving power and then applying the power to the coil (22). The power supply section (30) includes a commutator (31) and a brush (32). The commutator (31) is fitted around the lower end of the shaft (s) to be positioned between the core (21) and the lower bearing (b2). A segment for current application is formed on a circumferential outer surface of the commutator (31). The brush (32) has one end coupled to a side of the base (11) and the other end radially projecting to be electrically connected with the segment of the commutator (31).

In the cored type DC motor (1) constructed as described above, if current is applied to the coil (22) of the core (21) through the brush (32) and the commutator (31), electromagnetic force is generated between the coil (22) and magnet (m) facing each other. As a consequence, the shaft (s) and the core (21) on which the coil (22) is wound are rotated.

The cored type DC motor (1) constructed as mentioned above is manufactured through a series of processes given in FIG. 12. That is to say, the conventional method for manufacturing the cored type DC motor (1) comprises a first step of attaching the magnet (m) to the circumferential inner surface of the case (10), a second step of magnetizing the magnet (m) to have N and S polarities, a third step of assembling, innerly to the magnet (m) attached to the case (10), the rotator (20) including the shaft (s), core (21) and coil (22), a fourth step of setting a neutral point of the assembled motor (1), a fifth step of caulking the motor (1), and a sixth step of carrying out inspection.

Here, the magnet (m) is magnetized through a magnetizer in a state wherein it is positioned in the case (10), to have N and S polarities.

FIG. 3 is a schematic view illustrating a configuration in which a magnet is magnetized through a magnetizing yoke in the conventional cored type DC motor, and FIG. 4 is a cross-sectional view taken along the line A-A of FIG. 3.

As shown in FIGS. 3 and 4, when implementing the conventional procedure for magnetizing the magnet (m), first, the magnet (m) is attached to the circumferential inner surface of the case (10). Then, a magnetizing yoke (100) is placed around the case (10) so that it surrounds the case (10).

In this state, if a magnetization voltage is applied, magnetic flux is produced from the magnetizing yoke (100). The force of the magnetic flux magnetizes the entire magnet (m) attached to the circumferential inner surface of the case (10), to have N and S polarities.

At this time, a magnetization waveform of the magnet (m) magnetized by the magnetic flux produced from the magnetizing yoke (100) comprises a substantially sine wave as shown in FIG. 13 illustrating a relationship between time and magnetic flux.

If the magnet (m) is magnetized to have N and S polarities as described above, predetermined electromagnetic force is generated between the magnet (m) and the coil (22) which externally receives power. Due to this electromagnetic force, rotating force is generated in the coil (22), and the rotator (20) is resultingly rotated.

However, if the magnet (m) is magnetized through the above-described procedure, as can be readily seen from the figures, since the magnetic flux of the magnetizing yoke (100) acts on the magnet (m) after passing through the inside space of the case (10), a problem is caused in that a magnetization efficiency of the magnet (m) is deteriorated and performance of the motor is degraded.

In order to solve the problem, as shown in FIGS. 5 and 6, a method for improving a magnetization efficiency of the magnet (m) has been disclosed in the art. In this method, a back yoke 200 is provided in the inside space of the case (10) to serve as a medium for transmitting magnetic flux of the magnetizing yoke (100) to the magnet (m) without loss;

Here, FIG. 5 is a schematic view illustrating a configuration in which a magnet is magnetized through a magnetizing yoke and a back yoke in the conventional cored type DC motor, and FIG. 6 is a cross-sectional view taken along the line B-B of FIG. 5.

In this configuration, the magnet (m) is magnetized by the magnetizing yoke (100) and the back yoke (200) which are respectively placed outside and inside the case (10). Hereafter, this will be described in detail.

First, in a state wherein the magnet (m) is attached to the circumferential inner surface of the case (10), the back yoke (200) is inserted into the magnet (m), and the magnetizing yoke (100) is placed around the case (10) so that it surrounds the case (10).

When, as described above, the back yoke (200) and the magnetizing yoke (100) are respectively placed inside and outside the case (10) having the magnet (m) attached thereto, if a magnetization voltage is applied, magnetic flux is produced from the outside of the case (10), that is, from the magnetizing yoke (100) placed around the case (10) having the magnet (m) attached thereto. Then, the force of the magnetic flux magnetizes, through the back yoke (200), the entire magnet (m) to have N and S polarities. At this time, a magnetization waveform of the magnet (m) magnetized by the magnetic flux produced from the magnetizing yoke (100) comprises a substantially sine wave as shown in FIG. 13.

In the cored type DC motor, if the magnet (m) is magnetized to have N and S polarities as described above, predetermined electromagnetic force is generated between the magnet (m) and the coil (22) which externally receives power. Due to this electromagnetic force, rotating force is generated in the coil (22), and the rotator (20) is resultingly rotated.

FIG. 7 is a cross-sectional view illustrating the conventional coreless type DC motor.

As shown in FIG. 7, the coreless type DC motor largely comprises a case (50) defining an outer body of the DC motor, a magnet (m) which is attached to the case (50), a rotator (60) which interacts with the magnet (m) to generate rotating force, and a power supply section (70).

The case (50) has a hollow cylindrical contour. As can be readily seen from the drawings, an opened lower end of the case (50) is closed by a base (51), and an upper end of the case (50) is centrally defined with a hole and has an integral guide tube portion (50a) which is formed around the hole and extends downward into the case (50). A shaft (s) is inserted through the guide tube portion (50a) into the case (50). Upper and lower ends of the shaft (s) are inserted into and rotatably supported by a pair of bearings (b1 and b2) which are press-fitted into the base (51) and the upper end of the case (50), respectively.

The magnet (m) also has a cylindrical contour so that it is press-fitted around a circumferential outer surface of the guide tube portion (50a) of the case (50). An upper end surface of the magnet (m) is brought into contact with an inner surface of the upper end of the case (50), and a lower end surface of the magnet (m) is connected to the lower bearing (b2) which rotatably supports the shaft (s), whereby a stator which is integrally fixed to the case (50) is formed. A coil (62) is arranged around the magnet (m) so that a predetermined air gap is defined between the coil (62) and the magnet (m). The magnet (m) interacts with the coil (62) to generate electromagnetic force.

The rotator (60) includes the shaft (s) centrally disposed in the case (50) and rotatably supported by the upper and lower bearings (b1 and b2), a commutator (71) integrally coupled to the lower end of the shaft (s), and the coil (62) arranged around the magnet (m) with the predetermined air gap defined between the coil (62) and the magnet (m).

Here, the coil (62) is coupled, adjacent to a lower end thereof and on a circumferential inner surface thereof, with the commutator (71) which is structured to be integrally rotated with the shaft (s). Generally, the coil (62) is wound in the form of a polygon and pressed in an axial direction to define a sheet-shaped contour. If current is applied to the coil (62) through the commutator (71), the coil (62) interacts with the magnet (m) which is separated from the coil (62) by the predetermined air gap, to generate electromagnetic force. Thus, due to this electromagnetic force, rotation force is accomplished.

The power supply section (70) serves as a component element for externally receiving power and then applying the power to the coil (62). The power supply section (70) largely includes the commutator (71) and a brush (72). At this time, the commutator (71) is integrally coupled to the lower end of the shaft (s). A segment (not shown) for current application is formed on a circumferential outer surface of the commutator (71). The brush (72) has one end coupled to a side of the base (51) and the other end radially projecting to be electrically connected with the segment of the commutator (71). The brush (72) is wired to externally receive power.

In the conventional coreless type DC motor (2) constructed as mentioned above, if current is applied to the coil (72) through the brush (72) and the commutator (71), electromagnetic force is generated between the coil (62) and magnet (m) facing each other. As a consequence, the shaft (s) integrally connected with the coil 62 is rotated while being supported by the pair of bearings (b1 and b2).

In the same manner as the cored type DC motor aforementioned, the coreless type DC motor constructed as just described above is manufactured through the series of processes given in FIG. 12.

That is to say, the conventional method for manufacturing the coreless type DC motor (2) comprises a first step of attaching the magnet (m) to the circumferential outer surface of the guide tube portion (50a), a second step of magnetizing the magnet (m) to have N and S polarities, a third step of assembling, innerly to the magnet (m) attached to the guide tube portion (50a) of the case (50), the rotator (60) including the shaft (s), coil (62) and commutator (71), a fourth step of setting a neutral point of the assembled motor (2), a fifth step of caulking the motor (2), and a sixth step of carrying out inspection.

At this time, the magnet (m) is magnetized through a magnetizer in a state wherein it is positioned in the case (50), to have N and S polarities.

FIG. 8 is a schematic view illustrating a configuration in which a magnet is magnetized through a magnetizing yoke in the conventional coreless type DC motor, and FIG. 9 is a cross-sectional view taken along the line C-C of FIG. 8.

As shown in FIGS. 8 and 9, when implementing the conventional procedure for magnetizing the magnet (m), first, the magnet (m) is attached to the circumferential outer surface of the guide tube portion (50a) integrally formed with the case (50). Then, a magnetizing yoke (100) is placed around the case (50) so that it surrounds the entire case (50).

In this state, if a magnetization voltage is applied, magnetic flux is produced from the magnetizing yoke (100). The force of the magnetic flux magnetizes the entire magnet (m) positioned inside the case (50), to have N and S polarities. At this time, a magnetization waveform of the magnet (m) magnetized by the magnetic flux produced from the magnetizing yoke (100) comprises a substantially sine wave as shown in FIG. 13.

However, if the magnet (m) is magnetized through the above-described procedure, as can be readily seen from the figures, since the magnetic flux of the magnetizing yoke (100) acts on the magnet (m) after passing through the inside space of the case (50), a problem is caused in that a magnetization efficiency of the magnet (m) is deteriorated and performance of the motor is degraded.

In order to solve the problem, as shown in FIGS. 10 and 11, a method for transmitting magnetic flux of the magnetizing yoke (100) to the magnet (m) without loss has been disclosed in the art. In this method, a back yoke 200 is provided in a space defined in the case (50) to create a kind of magnetic circuit.

Here, FIG. 10 is a schematic view illustrating a configuration in which a magnet is magnetized through a magnetizing yoke and a back yoke in the conventional coreless type DC motor, and FIG. 11 is a cross-sectional view taken along the line D-D of FIG. 10.

In this configuration, the magnet (m) is magnetized by the magnetizing yoke (100) and the back yoke (200) which are respectively placed outside and inside the case (50). Hereafter, this will be described in detail.

First, in a state wherein the magnet (m) is attached to the circumferential outer surface of the guide tube portion (50a) which is integrally formed with the case (50) to extend downward, the back yoke (200) is installed so that it occupies a first annular space defined between the magnet (m) and case (50) and a second space defined in the guide tube portion (50a) of the case (50). At the same time with this, the magnetizing yoke (100) is placed around the case (50) so that it surrounds the case (50).

When, as described above, the back yoke (200) and the magnetizing yoke (100) are respectively placed inside and outside the case (50) having the magnet (m) positioned therein, if a magnetization voltage is applied, magnetic flux is produced from the outside of the case (50), that is, from the magnetizing yoke (100) placed around the case (50) having the magnet (m) positioned therein. Then, the force of the magnetic flux magnetizes, through the back yoke (200), the entire magnet (m) to have N and S polarities. At this time, a magnetization waveform of the magnet (m) magnetized by the magnetic flux produced from the magnetizing yoke (100) comprises a substantially sine wave as shown in FIG. 13.

In the coreless type DC motor, if the magnet (m) is magnetized to have N and S polarities as described above, predetermined electromagnetic force is generated between the magnet (m) and the coil (62). Due to this electromagnetic force, rotating force is generated in the coil (62), and the rotator (60) is resultingly rotated.

As can be readily seen from the above description, the cored type DC motor and the coreless type DC motor have the same component elements except that the cored type DC motor has the core, and are manufactured and magnetized in the same manner.

The conventional cored and coreless type DC motors having the above-described constructions suffer from defects as stated below, in that the magnetization procedure is implemented after the magnet is installed in the case.

In this regard, hereafter, description will be given in association with the cored type DC motor of FIG. 1, and the same reference numerals will be used to refer to the same component parts.

As a process is added due to positioning of the back yoke (200) in the case (10), workability and productivity are deteriorated. Also, because a number of back yokes having a variety of sizes must be prepared in conformity with sizes of magnets required in the conventional DC motors, a manufacturing cost of the DC motor cannot but be increased.

Specifically, if the rotator (20) is assembled in a state wherein the magnet (m) is magnetized as described above, a process for setting a neutral point is necessitated due to an armature reaction. When current is applied to the coil through the commutator from the brush (32), magnetic force is generated in a center portion. In this regard, the neutral point setting process is implemented to ensure that directions of magnetic force generated in the magnet (m) and the coil are precisely aligned with each other. By implementing the neutral point setting process, it is possible to obtain a high efficiency from the motor.

That is to say, as can be readily seen from FIG. 14, considering the fact that a torque is proportional to the product of flux (Φ) and current (I), if a current application timing is optimized by setting the neutral point, directions of magnetic force generated in the magnet (m) and coil can be precisely aligned with each other, whereby it is possible to increase torque.

The neutral point setting process significantly influences performance of the motor. Therefore, in the case that the rotator (20) is assembled after magnetization of the magnet (m) as in the conventional DC motor, the neutral point setting process must be necessarily implemented.

FIG. 15 is a view schematically illustrating a neutral point setting process implemented in the conventional DC motor. As can be readily seen from FIG. 15, the neutral point setting process is implemented in such a way as to align N and S pole positions of the magnet (m) with the line connecting two contact points (p) of the brush (32). In this regard, it is the norm that a neutral point is set by finely varying an angle of the brush (32).

Also, when the motor is required to rotate in either clockwise or counterclockwise direction at a high speed, since it is difficult to know a rotating direction of the motor while implementing the neutral point setting process, defects are caused and a processing time is lengthened.

Hence, due to the addition of the neutral point setting process, working efficiency and productivity are deteriorated, a defective proportion is increased, and it is difficult to accomplish standardization of end products.

### SUMMARY OF THE INVENTION

Accordingly, the present invention has been made in an effort to solve the problems occurring in the related art, and an object of the present invention is to provide a DC motor in which a magnet is magnetized after assembly of the motor is completed, while obviating the need for a separate back yoke and a separate neutral point setting process, thereby improving driving characteristics and allowing a rotating direction of the motor to be easily grasped.

In order to achieve the above object, according to one aspect of the present invention, there is provided a method for manufacturing a cored type DC motor, comprising the steps of: attaching a magnet to a circumferential inner surface of a case; rotatably assembling a rotator including a shaft, a coil and a core in a manner such that a predetermined air-gap is defined between the magnet and the rotator; positioning the case having the magnet attached thereto, in a magnetizing yoke; and magnetizing the magnet.

According to another aspect of the present invention, the magnetizing yoke magnetizes the magnet in a state in which a neutral point and a rotating direction are set.

According to another aspect of the present invention, the method further comprises the step of airtightly caulking the cored type DC motor after the assembling and magnetizing steps are completed.

According to another aspect of the present invention, the caulking step is implemented before or after the magnet is magnetized.

According to another aspect of the present invention, the step of assembling the rotator comprises the sub steps of: coupling a commutator which is formed with a segment for current application, to a circumferential outer surface of one end of the shaft; and coupling a brush which is to be brought into electrical connect with the segment of the commutator, to a side of the case.

According to another aspect of the present invention, the step of magnetizing the magnet comprises the sub step of applying a high voltage to the magnetizing yoke.

According to still another aspect of the present invention, the rotator serves as a back yoke for magnetizing the magnet to have N and S polarities.

According to yet still another aspect of the present invention, there is provided a method for manufacturing a coreless type DC motor, comprising the steps of: attaching a magnet to a circumferential outer surface of a guide tube portion of a case; rotatably assembling a coreless rotator including a shaft and a coil in a manner such that a predetermined air gap is defined between the magnet and the coreless rotator; positioning the case having the magnet attached thereto, in a magnetizing yoke; and magnetizing the magnet.

### BRIEF DESCRIPTION OF THE DRAWINGS

The above objects, and other features and advantages of the present invention will become more apparent after a reading of the following detailed description when taken in conjunction with the drawings, in which:

FIG. 1 is a cross-sectional view illustrating the conventional cored type DC motor;

FIG. 2 is a perspective view illustrating a rotator of the DC motor shown FIG. 1, with a brush brought into contact with a commutator;

FIG. 3 is a schematic view illustrating a configuration in which a magnet is magnetized through a magnetizing yoke in the conventional cored type DC motor;

FIG. 4 is a cross-sectional view taken along the line A-A of FIG. 3;

FIG. 5 is a schematic view illustrating a configuration in which a magnet is magnetized through a magnetizing yoke and a back yoke in the conventional cored type DC motor;

FIG. 6 is a cross-sectional view taken along the line B-B of FIG. 5;

FIG. 7 is a cross-sectional view illustrating the conventional coreless type DC motor;

FIG. 8 is a schematic view illustrating a configuration in which a magnet is magnetized through a magnetizing yoke in the conventional coreless type DC motor;

FIG. 9 is a cross-sectional view taken along the line C-C of FIG. 8;

FIG. 10 is a schematic view illustrating a configuration in which a magnet is magnetized through a magnetizing yoke and a back yoke in the conventional coreless type DC motor;

FIG. 11 is a cross-sectional view taken along the line D-D of FIG. 10.

FIG. 12 is a flow chart illustrating the conventional method for manufacturing a DC motor;

FIG. 13 is a diagram illustrating a magnetization waveform of a magnet in the conventional DC motor;

FIG. 14 is a waveform diagram illustrating a relationship between magnetic flux and electric current with the lapse of time;

FIG. 15 is a view schematically illustrating a neutral point setting process implemented in the conventional DC motor;

FIG. 16 is a flow chart illustrating a DC motor magnetization procedure in accordance with one embodiment of the present invention;

FIG. 17 is a flow chart illustrating a DC motor magnetization procedure in accordance with another embodiment of the present invention;

FIG. 18 is a schematic view illustrating a configuration in which a magnet is magnetized through a magnetizing yoke in a cored type DC motor according to the present invention;

FIG. 19 is a cross-sectional view taken along the line E-E of FIG. 18;

FIG. 20 is a schematic view illustrating a configuration in which a magnet is magnetized through a magnetizing yoke in a coreless type DC motor according to the present invention; and

FIG. 21 is a cross-sectional view taken along the line F-F of FIG. 20.

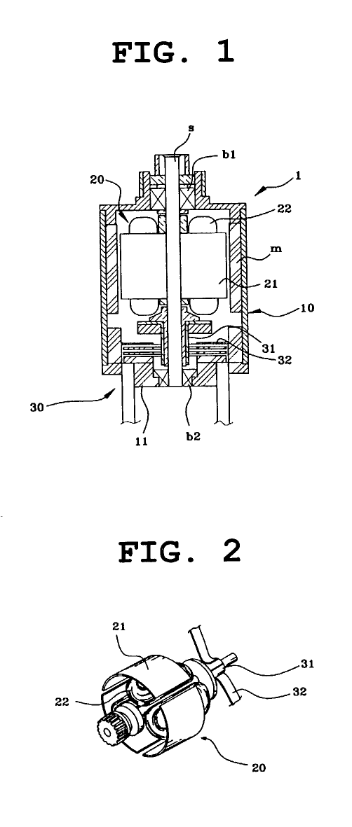

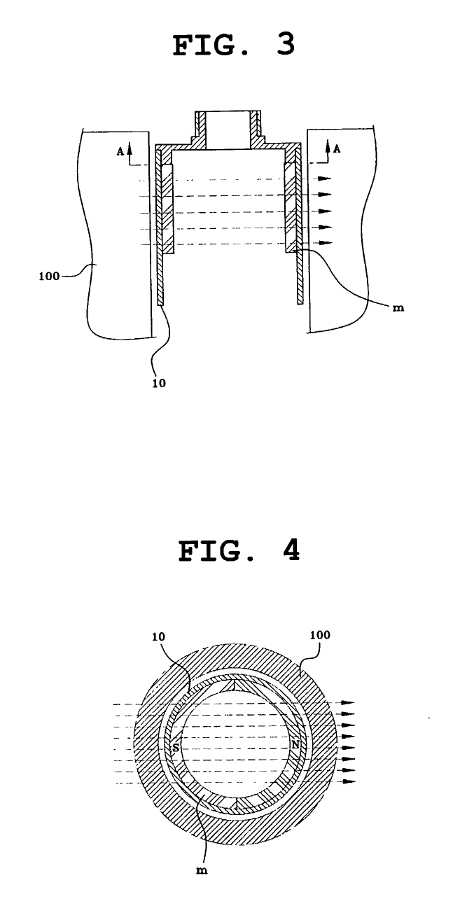

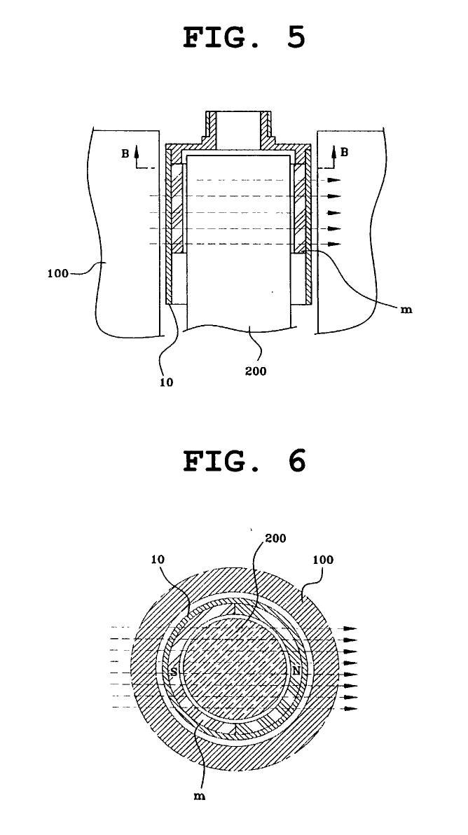

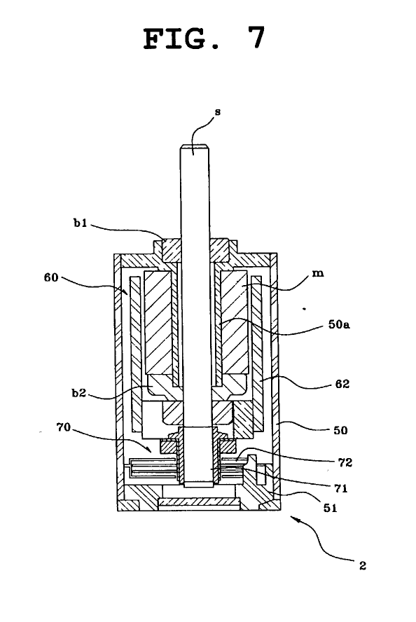

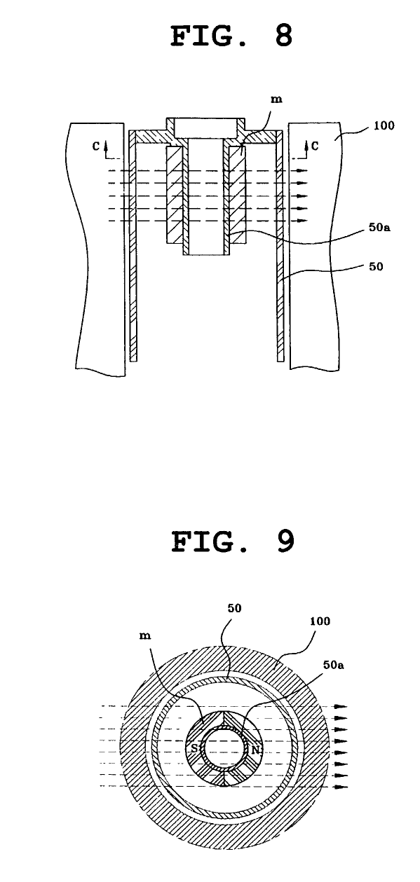

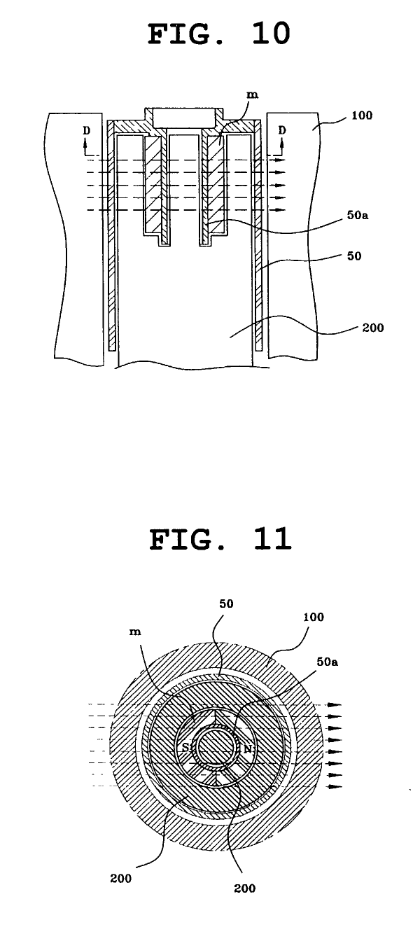

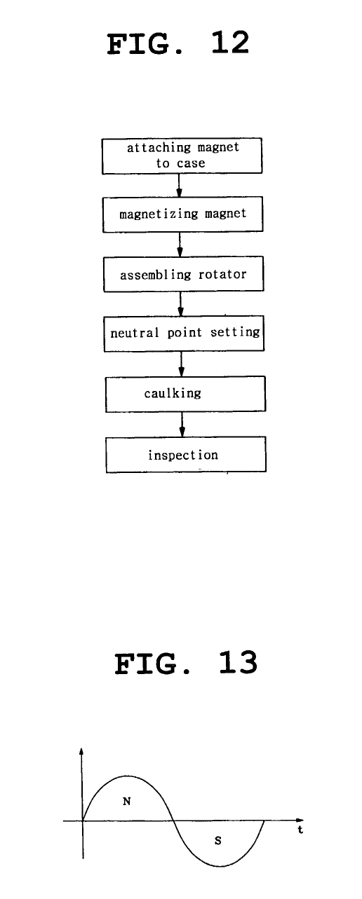

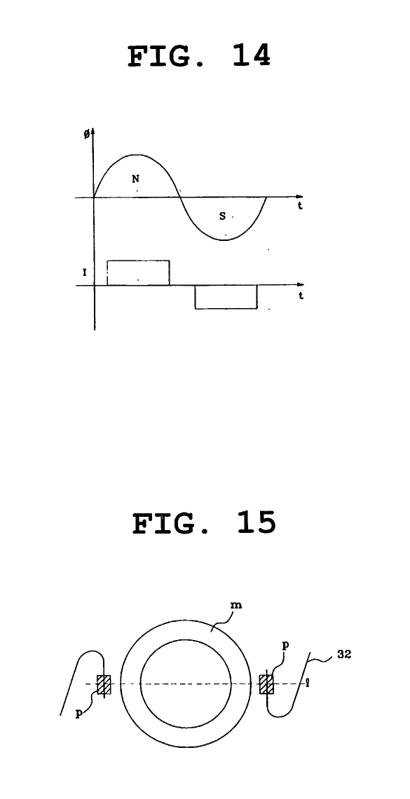

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

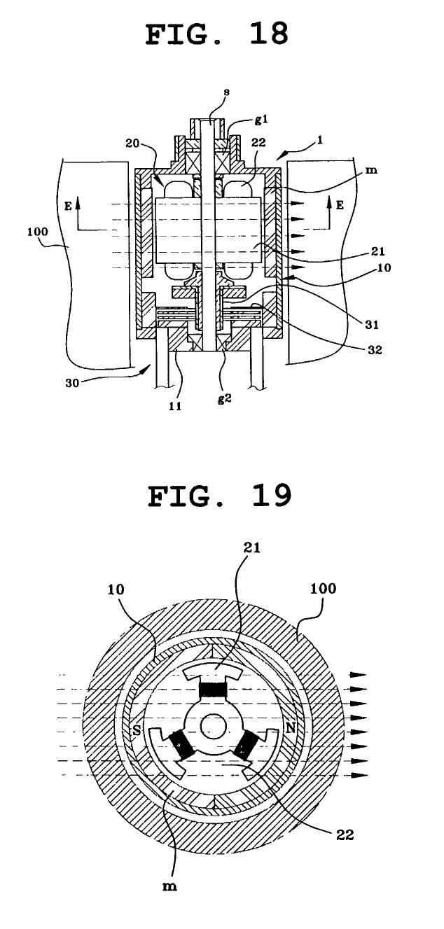

FIG. 18 is a schematic view illustrating a configuration in which a magnet is magnetized through a magnetizing yoke in a cored type DC motor according to the present invention, and FIG. 19 is a cross-sectional view taken along the line E-E of FIG. 18. A construction of a cored type DC motor as shown in these drawings will be concisely described below.

The cored type DC motor (1) has a core (21) on which a coil (22) is wound. The core (21) constitutes a rotator (20). The cored type DC motor (1) largely comprises a case (10) having a tubular contour which is opened at upper and lower ends thereof, a magnet (m) brought into close contact with a circumferential inner surface of the case (10), and the rotator (20) assembled in the magnet (m) with a predetermined air gap defined between the magnet (m) and the rotator (20). At this time, the rotator (20) includes a shaft (s) rotatably supported by upper and lower bearings (b1 and b2) which are press-fitted into upper and lower ends of the case (10), a core (21) fitted around a circumferential outer surface of the shaft (s), and a coil (22) wound on the core (21) and interacting with the magnet (m) to generate electromagnetic force.

A commutator (31) which is formed with a segment for current application is fitted around a lower end of the shaft (s). A brush (32) to be electrically connected with the segment of the commutator (31) is fixed with respect to the lower end of the case (10) by a base (11).

The above-described construction of the cored type DC motor (1) is substantially the same as in the conventional art. However, the present invention is differentiated from the conventional art in that the magnet (m) is magnetized after assembly of the rotator (20) is completed, in such a way as to allow the rotator (20) to serve as the back yoke of the conventional art, whereby a manufacturing procedure is simplified and driving characteristics of the DC motor (1) are significantly improved.

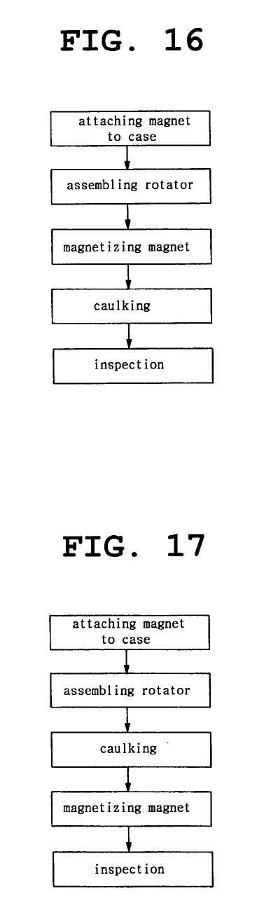

That is to say, as shown in FIG. 16, a method for manufacturing a cored type DC motor in accordance with one embodiment of the present invention comprises a first step of assembling respective structural components to form the DC motor, a second step of magnetizing the magnet, a third step of caulking the base with respect to the case, and a fourth step of inspecting a quality of the motor.

Hereafter, the respective steps will be described in detail with reference to the cored type DC motor shown in FIGS. 18 and 19.

The first step of forming the cored type DC motor includes a process of attaching the cylindrical magnet (m) to the circumferential inner surface of the case (10) having the tubular contour, and a process of assembling the rotator (20) innerly to the magnet (m).

Here, the magnet (m) is affixed to the case (10) by an adhesive or the like in a state wherein it is brought into close contact with the circumferential inner surface of the case (10). The magnet (m) has a contour substantially corresponding to that of the circumferential inner surface of the case (10).

With the core (21) fitted around the circumferential outer surface of the shaft (s) and the coil (22) wound on the core (21), the rotator (20) is assembled to the case (10). At this time, the rotator (20) is assembled in a manner such that upper and lower ends of the shaft (s) are rotatably supported by the upper and lower bearings (b1 and b2), respectively.

Also, as described above, the commutator (31) which is formed with the segment for current application is fitted around the lower end of the shaft (s). The base is assembled to the lower end of the case (10) to fixedly maintain the brush (32) which is to be electrically connected with the segment of the commutator (31).

The second step of magnetizing the magnet (m) includes a process of positioning the DC motor (1) with the structural components assembled, in a magnetizing yoke (100) of a magnetizer, and a process of magnetizing the magnet (m) to have N and S polarities, by applying a high voltage to the magnetizing yoke (100).

Here, in the magnetizer, by applying a high magnetization voltage to the magnetization yoke (100) surrounding the case (10), magnetic flux is generated from the magnetization yoke (100). The magnetic flux passes through the case (10) and is transmitted to the magnet (m). At this time, since the rotator (20) positioned inside the magnet (m) is formed of a magnetic material, the rotator (20) serves as the back yoke of the conventional art. Due to this fact, the magnet (m) is magnetized to have N and S polarities. Meanwhile, in the second step of magnetizing the magnet (m), the magnetizing yoke (100) magnetizes the magnet (m) in a state wherein a neutral point of the DC motor (1) and a rotating direction of the rotator (20) are properly set.

The magnet (m) magnetized in this way to have N and S polarities interacts with the coil (22) externally receiving power, to generate electromagnetic force. Due to this electromagnetic force, as rotating force is generated in the coil (22), the rotator (20) is rotated.

The third step of caulking the motor (1) includes a process of caulking and thereby airtightly sealing the DC motor (1) having undergone the assembling and magnetizing processes.

The fourth step of inspecting a quality of the DC motor (1) includes a process of inspecting for abnormalities of the DC motor (1) which is caulked.

As a consequence, in the DC motor (1) manufactured by magnetizing the magnet (m) after completion of assembly, since the magnetizing yoke (100) magnetizes the magnet (m) in a state wherein a neutral point of the DC motor (1) and a rotating direction of the rotator (20) are properly set, a separate neutral point setting process is not required and a manufacturing procedure can be simplified.

FIG. 17 is a flow chart illustrating a DC motor magnetization procedure in accordance with another embodiment of the present invention.

As can be readily seen from FIG. 17, the method according to this embodiment of the present invention comprises a first step of assembling respective structural components to form the DC motor, a second step of caulking the base with respect to the case, a third step of magnetizing the magnet, and a fourth step of inspecting a quality of the motor.

Hereafter, the respective steps will be described in detail with reference to the cored type DC motor shown in FIGS. 18 and 19.

The first step of forming the cored type DC motor includes a process of attaching the cylindrical magnet (m) to the circumferential inner surface of the case (10) having the tubular contour, and a process of assembling the rotator (20) innerly to the magnet (m).

Here, the magnet (m) is affixed to the case (10) by an adhesive or the like in a state wherein it is brought into close contact with the circumferential inner surface of the case (10). The magnet (m) has a contour substantially corresponding to that of the circumferential inner surface of the case (10).

With the core (21) fitted around the circumferential outer surface of the shaft (s) and the coil (22) wound on the core (21), the rotator (20) is assembled to the case (10). At this time, the rotator (20) is assembled in a manner such that upper and lower ends of the shaft (s) are rotatably supported by the upper and lower bearings (b1 and b2), respectively. Also, as described above, the commutator (31) which is formed with the segment for current application is fitted around the lower end of the shaft (s). The base (11) is assembled to the lower end of the case (10) to fixedly maintain the brush (32) which is to be electrically connected with the segment of the commutator (31).

The second step of caulking the motor (1) includes a process of caulking and thereby airtightly sealing the DC motor (1) having undergone the assembling process.

The third step of magnetizing the magnet (m) includes a process of positioning the DC motor (1) with the structural components assembled, in a magnetizing yoke (100) of a magnetizer, and a process of magnetizing the magnet (m) to have N and S polarities, by applying a high voltage to the magnetizing yoke (100).

Here, in the magnetizer, by applying a high magnetization voltage to the magnetization yoke (100) surrounding the case (10), magnetic flux is generated from the magnetization yoke (100). The magnetic flux passes through the case (10) and is transmitted to the magnet (m). At this time, since the rotator (20) positioned inside the magnet (m) is formed of a magnetic material, the rotator (20) serves as the back yoke of the conventional art. Due to this fact, the magnet (m) is magnetized to have N and S polarities. Meanwhile, in the second step of magnetizing the magnet (m), the magnetizing yoke (100) magnetizes the magnet (m) in a state wherein a neutral point of the DC motor (1) and a rotating direction of the rotator (20) are properly set.

The magnet (m) magnetized in this way to have N and S polarities interacts with the coil (22) externally receiving power, to generate electromagnetic force. Due to this electromagnetic force, as rotating force is generated in the coil (22), the rotator (20) is rotated.

The fourth step of inspecting a quality of the DC motor (1) includes a process of inspecting for abnormalities of the DC motor (1) which is caulked.

As a consequence, in the DC motor (1) manufactured by magnetizing the magnet (m) after completion of assembly, since the magnetizing yoke (100) magnetizes the magnet (m) in a state wherein a neutral point of the DC motor (1) and a rotating direction of the rotator (20) are properly set, a separate neutral point setting process is not required and a manufacturing procedure can be simplified.

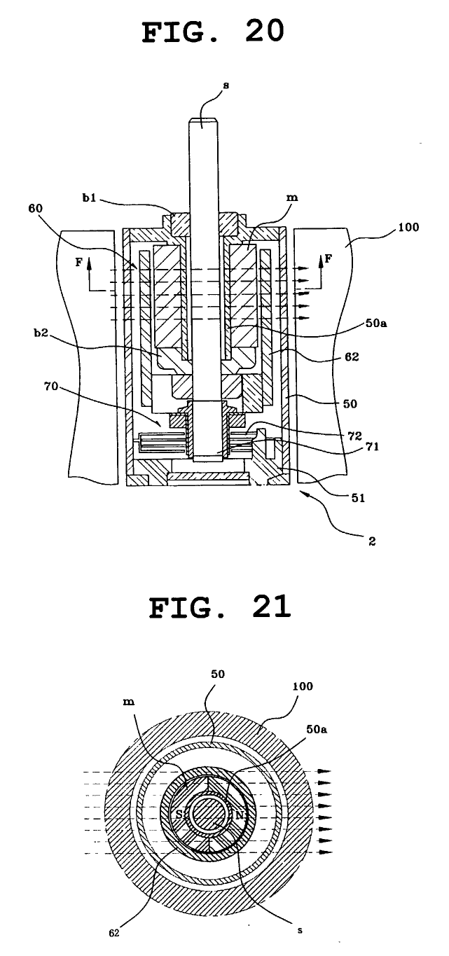

FIG. 20 is a schematic view illustrating a configuration in which a magnet is magnetized through a magnetizing yoke in a coreless type DC motor according to the present invention, and FIG. 21 is a cross-sectional view taken along the line F-F of FIG. 20. A construction of a coreless type DC motor as shown in these drawings will be concisely described below.

Generally, in a coreless type DC motor, a rotator does not have a separate core, and instead, a coil is wound in the form of a polygon and pressed in an axial direction to define a sheet-shaped contour. The coreless type DC motor largely comprises a case (50), a magnet (m), a rotator (60), and a power supply section (70).

The case (50) has a hollow cylindrical contour which is opened at a lower end thereof. An opened lower end of the case (50) is closed by a base (51), and an upper end of the case (50) is centrally defined with a hole and has an integral guide tube portion (50a) which is formed around the hole and extends downward into the case (50). At this time, a shaft (s) is inserted through the guide tube portion (50a) into the case (50). Upper and lower ends of the shaft (s) are inserted into and rotatably supported by a pair of bearings (b1 and b2) which are press-fitted into the base (51) and the upper end of the case (50), respectively.

The magnet (m) is press-fitted around a circumferential outer surface of the guide tube portion (50a) of the case (50). An upper end surface of the magnet (m) is brought into contact with an inner surface of the upper end of the case (50), and a lower end surface of the magnet (m) is connected to the lower bearing (b2) which rotatably supports the shaft (s), whereby a stator which is integrally fixed to the case (50) is formed. A coil (62) is arranged around the magnet (m) so that a predetermined air gap is defined between the coil (62) and the magnet (m). The magnet (m) interacts with the coil (62) to generate electromagnetic force.

The rotator (60) includes the shaft (s) centrally disposed in the case (50) and rotatably supported by the upper and lower bearings (b1 and b2), a commutator (71) integrally coupled to the lower end of the shaft (s), and the coil (62) arranged around the magnet (m) with the predetermined air gap defined between the coil (62) and the magnet (m). The coil (62) also has a cylindrical contour.

The power supply section (70) largely includes the commutator (71) and a brush (72). At this time, the commutator (71) is integrally coupled to the lower end of the shaft (s). A segment (not shown) for current application is formed on a circumferential outer surface of the commutator (71). The brush (72) has one end coupled to a side of the base (51) and the other end radially projecting to be electrically connected with the segment of the commutator (71). The brush (72) is wired to externally receive power.

The above-described construction of the coreless type DC motor is substantially the same as in the conventional art. However, the present invention is differentiated from the conventional art in that the magnet (m) is magnetized after the rotator (20) is assembled in the case (50), whereby a manufacturing procedure is simplified and driving characteristics of the DC motor (1) are significantly improved.

That is to say, as shown in FIG. 16, a method for manufacturing a coreless type DC motor according to the present invention comprises a first step of assembling respective structural components to form the DC motor, a second step of magnetizing the magnet assembled in the case, a third step of caulking the base with respect to the case, and a fourth step of inspecting a quality of the motor.

Hereafter, the respective steps will be described in detail with reference to the coreless type DC motor shown in FIGS. 20 and 21.

The first step of forming the careless type DC motor includes a process of attaching the cylindrical magnet (m) to the circumferential outer surface of the guide tube portion (50a) of the case (10) having the tubular contour, and a process of assembling the coil 62 of the rotator (60) around the magnet (m) and the shaft (s) in the guide tube portion 50a. Here, the magnet (m) is affixed to the case (50) by an adhesive or the like in a state wherein it is press-fitted around the circumferential outer surface of the guide tube portion (50a) of the case (50).

Further, the rotator 60 is assembled to the case 50 with the commutator 71 and the coil 62 coupled to one end portion of the circumferential outer surface of the shaft (s). At this time, the shaft (s) is rotatably supported by the pair of bearings (b1 and b2) which are provided to the upper and lower ends of the case (50).

Meanwhile, the base 51 is assembled to the lower end of the case 50. The base 51 functions to fixedly maintain the brush (72) which is to be brought into electrical contact with the segment of the commutator (71).

The second step of magnetizing the magnet (m) comprises a process of positioning the DC motor with the structural components assembled, in a magnetizing yoke (100) of a magnetizer, and a process of magnetizing the magnet (m) to have N and S polarities, by applying a high voltage to the magnetizing yoke (100).

Here, in the magnetizer, by applying a high magnetization voltage to the magnetization yoke (100) surrounding the case (50), magnetic flux is generated from the magnetization yoke (100). The magnetic flux passes through the case (50) and is transmitted to the magnet (m). At this time, since the rotator (60) positioned inside the magnet (m) is formed of a magnetic material and cooperates with the magnetizing yoke (100) to serve as the back yoke of the conventional art. Due to this fact, the magnet (m) is magnetized to have N and S polarities. Meanwhile, in the second step of magnetizing the magnet (m), the magnetizing yoke (100) magnetizes the magnet (m) in a state wherein a neutral point of the DC motor and a rotating direction of the rotator (60) are properly set.

The magnet (m) magnetized in this way to have N and S polarities interacts with the coil (62) externally receiving power, to generate electromagnetic force. Due to this electromagnetic force, as rotating force is generated in the coil (62), the rotator (60) is rotated.

The third step of caulking the motor (2) includes a process of caulking and thereby airtightly sealing the DC motor (2) having undergone the assembling and magnetizing processes.

The fourth step of inspecting a quality of the DC motor (2) includes a process of inspecting for abnormalities of the DC motor (2) which is caulked.

As a consequence, in the coreless type DC motor (2) manufactured by magnetizing the magnet (m) after completion of assembly, since the magnetizing yoke (100) magnetizes the magnet (m) in a state wherein a neutral point of the DC motor (2) and a rotating direction of the rotator (60) are properly set, a separate neutral point setting process is not required and a manufacturing procedure can be simplified.

FIG. 17 is a flow chart illustrating a DC motor magnetization procedure in accordance with another embodiment of the present invention.

As can be readily seen from FIG. 17, the method according to this embodiment of the present invention comprises a first step of assembling respective structural components to form the DC motor, a second step of caulking the base with respect to the case, a third step of magnetizing the magnet, and a fourth step of inspecting a quality of the motor.

Hereafter, the respective steps will be described in detail with reference to the coreless type DC motor shown in FIGS. 20 and 21.

The first step of forming the coreless type DC motor includes a process of attaching the cylindrical magnet (m) to the circumferential outer surface of the guide tube portion (50a) of the case (10) having the tubular contour, and a process of assembling the coil 62 of the rotator (60) around the magnet (m) and the shaft (s) in the guide tube portion 50a. Here, the magnet (m) is affixed to the case (50) by an adhesive or the like in a state wherein it is press-fitted around the circumferential outer surface of the guide tube portion (50a) of the case (50).

Further, the rotator 60 is assembled to the case 50 with the commutator 71 and the coil 62 coupled to one end portion of the circumferential outer surface of the shaft (s). At this time, the shaft (s) is rotatably supported by the pair of bearings (b1 and b2) which are provided to the upper and lower ends of the case (50).

Meanwhile, the base 51 is assembled to the lower end of the case 50. The base 51 functions to fixedly maintain the brush (72) which is to be brought into electrical contact with the segment of the commutator (71).

The second step of caulking the motor (2) includes a process of caulking and thereby airtightly sealing the DC motor (2) having undergone the assembling process.

The third step of magnetizing the magnet (m) comprises a process of positioning the DC motor with the structural components assembled, in a magnetizing yoke (100) of a magnetizer, and a process of magnetizing the magnet (m) to have N and S polarities, by applying a high voltage to the magnetizing yoke (100).

Here, in the magnetizer, by applying a high magnetization voltage to the magnetization yoke (100) surrounding the case (50), magnetic flux is generated from the magnetization yoke (100). The magnetic flux passes through the case (50) and is transmitted to the magnet (m). At this time, since the rotator (60) positioned inside the magnet (m) is formed of a magnetic material and cooperates with the magnetizing yoke (100) to serve as the back yoke of the conventional art. Due to this fact, the magnet (m) is magnetized to have N and S polarities. Meanwhile, in the second step of magnetizing the magnet (m), the magnetizing yoke (100) magnetizes the magnet (m) in a state wherein a neutral point of the DC motor and a rotating direction of the rotator (60) are properly set.

The magnet (m) magnetized in this way to have N and S polarities interacts with the coil (62) externally receiving power, to generate electromagnetic force. Due to this electromagnetic force, as rotating force is generated in the coil (62), the rotator (60) is rotated.

The fourth step of inspecting a quality of the DC motor (2) includes a process of inspecting for abnormalities of the DC motor (2) which is caulked.

As a consequence, in the coreless type DC motor (2) manufactured by magnetizing the magnet (m) after completion of assembly, since the magnetizing yoke (100) magnetizes the magnet (m) in a state wherein a neutral point of the DC motor (2) and a rotating direction of the rotator (60) are properly set, a separate neutral point setting process is not required and a manufacturing procedure can be simplified.

As apparent from the above description, the method for manufacturing a DC motor according to the present invention provides advantages in that, since a magnet is magnetized after assembly of the motor is completed, a structure of a magnetizer is simplified when compared to the conventional art and a manufacturing cost of the DC motor is reduced.

Also, differently from the conventional art, because a process for inserting a back yoke in the magnet is not needed, due to a decrease in the number of processes, workability and productivity can be improved.

In particular, by the fact that a neutral point and a rotating direction can be set while implementing a magnetizing process, the number of processes can be remarkably decreased. Also, since magnetization loss can be reduced due to the presence of a rotator, a torque can be increased and driving characteristics can be improved.

In the drawings and specification, there have been disclosed typical preferred embodiments of the invention and, although specific terms are employed, they are used in a generic and descriptive sense only and not for purposes of limitation, the scope of the invention being set forth in the following claims. For example, contours and structures of various component parts explained in the above embodiments may be changed in a diversity of ways.

What is claimed is:

1. A method for manufacturing a cored type DC motor, comprising the steps of:
attaching a magnet to a circumferential inner surface of a case;
rotatably assembling a rotator including a shaft, a coil and a core in a manner such that a predetermined air gap is defined between the magnet and the rotator;
positioning the case having the magnet attached thereto, in a magnetizing yoke; and
magnetizing the magnet.

2. The method as set forth in claim 1, wherein the magnetizing yoke magnetizes the magnet in a state in which a neutral point and a rotating direction are set.

3. The method as set forth in claim 1, further comprising the step of:
airtightly caulking the cored type DC motor after the assembling and magnetizing steps are completed.

4. The method as set forth in claim 3, wherein the caulking step is implemented before or after the magnet is magnetized.

5. The method as set forth in claim 1, wherein the step of assembling the rotator comprises the sub steps of:
coupling a commutator which is formed with a segment for current application, to a circumferential outer surface of one end of the shaft; and
coupling a brush which is to be brought into electrical connect with the segment of the commutator, to a side of the case.

6. The method as set forth in claim 1, wherein the step of magnetizing the magnet comprises the sub step of applying a high voltage to the magnetizing yoke.

7. The method as set forth in claim 1, wherein the rotator serves as a back yoke for magnetizing the magnet to have N and S polarities.

8. A method for manufacturing a coreless type DC motor, comprising the steps of:
attaching a magnet to a circumferential outer surface of a guide tube portion of a case;
rotatably assembling a coreless rotator including a shaft and a coil in a manner such that a predetermined air gap is defined between the magnet and the coreless rotator;
positioning the case having the magnet attached thereto, in a magnetizing yoke; and
magnetizing the magnet.

9. The method as set forth in claim 8, wherein the magnetizing yoke magnetizes the magnet in a state in which a neutral point and a rotating direction are set.

10. The method as set forth in claim 8, further comprising the step of:
airtightly caulking the cored type DC motor after the assembling and magnetizing steps are completed.

11. The method as set forth in claim 10, wherein the caulking step is implemented before or after the magnet is magnetized.

12. The method as set forth in claim 8, wherein the step of assembling the rotator comprises the sub steps of:
coupling a commutator which is formed with a segment for current application, to a circumferential outer surface of one end of the shaft; and
coupling a brush which is to be brought into electrical connect with the segment of the commutator, to a side of the case.

13. The method as set forth in claim 8, wherein the step of magnetizing the magnet comprises the sub step of applying a high voltage to the magnetizing yoke.

14. The method as set forth in claim 8, wherein the rotator serves as a back yoke for magnetizing the magnet to have N and S polarities.
